(19) United States
(12) Patent Application Publication
(10) Pub. No.: US 2003/0118901 A1
(43) Pub. Date: Jun. 26, 2003

(54) Battery of the type comprising a zinc can and a collector consisting of carbon for the cathode

(76) Inventor: Jozef Franciscus Elizabeth Gootzen, Voorhout (NL)

Correspondence Address: STEVENS DAVIS MILLER & MOSHER, LLP, 1615 L STREET, NW, SUITE 850, WASHINGTON, DC, 20036, US

(21) Appl. No.: 10/220,245

(22) PCT Filed: Mar. 5, 2001
(86) PCT No.: PCT/NL01/00183

(51) Int. Cl. H01M 2/02; H01M 4/66; H01M 4/42

(52) U.S. Cl. 429/168; 429/176; 429/229; 429/234

(57) ABSTRACT

Battery of the type comprising a zinc can, the bottom of which is in contact with the negative terminal, and a collector which consists of carbon for the cathode, the zinc can be successively surrounded by a layer of electrically insulating material and a protective metal casing, the metal casing of which battery, on the inner side, comprises an organic coating layer which serves as the layer of electrically insulating material.

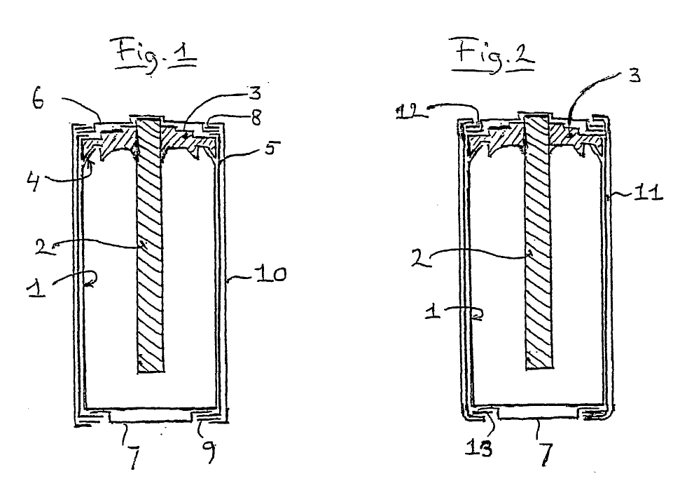

The invention relates to a battery of the type comprising a zinc can, the bottom of which is in contact with the negative terminal, and a collector which consists of carbon for the cathode, the zinc can being successively surrounded by a layer of electrically insulating material and a protective metal casing. Batteries of this type are generally known. FIG. 1 in the description of the figures and the parts of this description which refer to this figure diagrammatically illustrate the design of a known battery of this type. In this known battery design, the top side of the zinc can is sealed by means of a plastic sealing ring, in also which the carbon rod is secured in a sealed manner.

Since, in this battery, the zinc can participates in the galvanic process inside the battery, it will become weaker and be corroded over the course of time. There is a real danger that, over the course of time, electrolyte may begin to leak out of the battery through the weakened zinc can. To prevent this, in the known design a plastic shrink tube is usually fitted around the zinc can, which shrink tube also serves as a layer of electrically insulating material. To protect the battery from external damage and to allow it to be printed on, a metal casing is generally fitted around the shrink tube. This metal casing then generally comprises a pre-printed metal wrapper which is closed by means of a longitudinal seam. This sleeve which has been formed in this way can then be flanged inwards at the ends in order to enclose the battery structure. In doing so, it is also possible to enclose other elements of the battery, such as a metal cap which is in contact with the free end of the carbon cathode, a metal cap resting against the bottom of the zinc can and insulating rings to be able to fit these metal caps such that they are electrically insulated from the metal casing.

The use of a shrink tube has been found to be a drawback. The shrink film used for this purpose is a relatively expensive construction element and fitting it takes time and is therefore also expensive. Finally, an effective shrink tube requires a relatively thick shrink film, which takes up additional space in the battery.

It is an object of the present invention to alleviate the described drawbacks. For this purpose, the invention consists in the fact that the metal casing, on the inner side, comprises an organic coating layer which serves as the layer of electrically insulating material. It is then possible to omit the shrink tube. Applying an organic coating layer to metal plate is a generally known technique, it being possible for these coating layers to be applied in all kinds of thicknesses and with all kinds of properties. It has been found that various coatings with, for example, polyesters, polyolefins, etc., are suitable for this use according to the invention.

It should be noted that the metal casing does not fulfil an electrical function in the galvanic process within the battery.

According to the invention, the metal casing may also be provided with an organic coating layer on the outer side, which coating layer may be printable or may even have been printed on in advance. Unlike the known metal casing, this then involves the use of a metal plate, for example a steel plate, which has been coated on two sides, the coating layer on the inner side of the metal casing having the function of providing electrical insulation with respect to the zinc can and the outer side having the function of being printable and possibly of protecting the metal plate itself.

The invention also relates to the novel battery in which the metal casing consists of a wrapper with a longitudinal seam, which wrapper is curled inwards at the ends of the battery, the curled edges formed enclosing the components of the battery to form a cohesive unit. It is then particularly advantageous if the organic coating layer on the inner side of the wrapper comprises a thermoplastic which, at the location of the longitudinal seam, has been temporarily heated so that the edges of the seam adhere to one another. The result is a hermetic seal, with the result that it is no longer possible for electrolyte to leak out.

Although it is possible for the wrapper initially to be produced from an uncoated metal plate which is then provided with an organic coating layer on one or both sides, according to the invention it is preferable for the wrapper to be made from a metal plate which has already been provided with an organic coating layer.

The invention will now be explained with reference to a number of figures.

FIG. 1 diagrammatically depicts a single battery of the zinc-carbon type.

FIG. 2 shows the variant of this battery according to the invention.

In FIG. 1, reference numeral 1 denotes a zinc can which forms the anode in a zinc-carbon battery, in which a carbon rod as collector for the cathode is denoted by reference numeral 2. As a rule, the carbon rod 2 will consist at least partially of graphite. The space between zinc can 1 and carbon rod 2 is filled with cathode material, a mixture of manganese dioxide, carbon powder and electrolyte. The design and filling of this space are not explained in more detail here, since they are generally known.

A plastic sealing ring 3 is positioned at the top end of the zinc can 1, in which ring the carbon rod 2 fits in a clamping and sealed manner. The shape of this sealing ring 3 is such that the top edge 4 of the zinc can is bent inwards in a clamping manner, thus forming a seal. A shrink tube 5 is arranged around the zinc can 1 and the sealing ring 3, the end edges of which tube extend around the bottom edge of the zinc can and the top edge of the sealing ring 3. Metal caps 6 and 7 are in contact with the free end of the carbon rod 2 and with the bottom of the zinc can 1, respectively. In this way, the positive and negative terminals of the battery are formed. Furthermore, caps 6 and 7 are held enclosed with the aid of a steel wrapper 10 around the battery, which steel wrapper is curled inwards at the ends. Insulating rings 8 and 9 may also be arranged between these curled portions and the steel caps 6 and 7, in order to ensure that the wrapper 10 cannot come into electrical contact with the terminals. The ends in the circumferential direction of the wrapper adjoin one another along a seam. To protect the steel wrapper 10 from corrosion, it may be provided with a layer of chromium, a layer of nickel, a layer of tin or another coating layer. It may also be provided with a decorative layer on the outer side.

FIG. 2 shows the variant of the known design illustrated in FIG. 1 in which the novel design according to the invention is employed. Corresponding components are denoted by corresponding reference numerals.

The most significant difference consists in the fact that the shrink tube 5 has been omitted, thus eliminating an expensive construction element, a labour-intensive operation of fitting this shrink tube has been omitted, and space has been saved in the direction of the diameter of the battery. The protective metal casing is now formed by a casing which on the inner side comprises an organic coating layer which also serves as a layer of electrically insulating material. This casing is once again designed as a wrapper, also with a longitudinal seam. However, since in this case the organic coating layer consists of a thermoplastic, the longitudinal seam for closing the battery is now initially temporarily heated until the edges of the seam have been made to adhere to one another by means of the organic coating layer. This ensures a better seal against leaking electrolyte. In this case too, the end edges of the wrapper are flanged inwards, with the result that the end caps 6 and 7 are once again enclosed. Sufficient electrical insulation between the wrapper and the metal caps 6 and 7 may or may not be obtained, depending on the thickness and quality of the organic coating layer. If desired, additional insulating rings 12 and 13 may also be fitted here.

1. Battery of the type comprising a zinc can, the bottom of which is in contact with the negative terminal, and a collector which consists of carbon for the cathode, the zinc can being successively surrounded by a layer of electrically insulating material and a protective metal casing, characterized in that the metal casing, on the inner side, comprises an organic coating layer which serves as the layer of electrically insulating material.

2. Battery according to claim 1, characterized in that the metal casing is also provided with an organic coating layer on the outer side, which coating layer is printable or is printed on.

3. Battery according to claim 1 or 2, characterized in that the metal casing consists of a wrapper with a longitudinal seam, which wrapper is curled inwards at the ends of the battery, the curled edges formed enclosing the components of the battery to form a cohesive unit.

4. Battery according to claim 3, characterized in that the organic coating layer on the inner side of the wrapper comprises a thermoplastic which, at the location of the longitudinal seam, has been temporarily heated so that the edges of the seam adhere to one another.

5. Battery according to claim 3 or 4, characterized in that the wrapper is produced from a metal plate provided with an organic coating layer.
